(19) United States
(12) Patent Application Publication
(10) Pub. No.: US 2011/0070018 A1
(43) Pub. Date: Mar. 24, 2011

(54) SYSTEM FOR ATTACHING AN ACCESSORY TO VEHICLE INTERIOR

(75) Inventors: Marc David Nedelman, Waterford, MI (US); John Andrew Stakoe, Bloomfield Hills, MI (US); Donald Joseph Woodward, Washington, MI (US); Leslie Raymond Hinds, Oxford, MI (US)

(73) Assignee: FORD GLOBAL TECHNOLOGIES, LLC, Dearborn, MI (US)

(21) Appl. No.: 12/564,952

(22) Filed: Sep. 23, 2009

(51) Int. Cl. F16B 3/00; A44B 21/00

(52) U.S. Cl. 403/24; 24/595.1

(57) ABSTRACT

A system for attaching accessories to a vehicle interior is provided. The system includes a quick-release receptacle formed in such surfaces as a windshield visor. Accessories having a T-shaped quick-release connector may be quickly and easily attached and removed for mounting on various surfaces of the vehicle interior.

### TECHNICAL FIELD

The disclosed invention relates generally to systems for attaching accessories to vehicle interiors. More particularly, the disclosed invention relates to a system for allowing the easy attachment and removal of a variety of vehicle accessories to surfaces on the vehicle interior.

### BACKGROUND OF THE INVENTION

In earlier days of motoring the driver and passengers carried very little with them in the vehicle. This was in part due to the fact that the majority of early vehicles were open touring cars which offered no security for articles left behind while the occupants were absent. Later hard top vehicles resolved part of this problem, but had inadequate security systems. This was also due in part to the fact that technology such as portable global positioning systems and cellular telephones and other personal communication devices had not yet developed so there was that much less to carry.

As vehicle occupants began to spend more and more time in the vehicle on the road and as more accessories of convenience became available, more and more such accessories were brought into the vehicle. In addition to cellular telephones, portable global positioning systems became available. Furthermore, the vehicle occupant was presented with a broader variety of entertainment systems and, coupled with improved vehicle quietness, began to bring into the vehicle such items as compact disks. Other more mundane items, such as tissue boxes, coins, sunglasses, and writing instruments became common in motor vehicles.

With all of these accessories now present in motor vehicles, occupants have become overwhelmed with the need for proper storage. Often cellular telephones, compact disks, and coins end up in arm rest storage bins or inadequately mounted on vehicle instrument panels or on vehicle seats. Once so placed, vehicle occupants have little hope of finding these items when needed quickly or conveniently.

Accordingly, as in so many areas of vehicle technology, there is room in the art of vehicle accessory storage systems for improved design and efficiencies, thus overcoming some of the limitations of known designs.

### SUMMARY OF THE INVENTION

The disclosed invention provides a system for the quick connection of an accessory to a surface of the inside of a vehicle and for the quick disconnection of that accessory from the surface. The system includes a quick-release receptacle fitted to an interior surface such as a windshield visor. Accessories having a T-shaped quick-release connector may be quickly and easily attached and removed for mounting on various surfaces of the vehicle interior. Such accessories may include, without limitation, tissue cases, coin holders, compact disk holders, a holder for miscellaneous accessories such as pens and credit cards, a note pad holder, a holder for sunglasses, a holder for a cellular telephone, and a holder for a global positioning device.

The quick-release receptacle may be attached to any one of a broad variety of interior surfaces. The quick-release receptacle and the T-shaped quick-release connector may be made from a variety of materials, but are preferably formed from a thermomolded or molded polymerized material such as nylon. The bodies of the accessories or accessory holders may be formed from the same material.

The disclosed invention provides a practical, convenient and inexpensive method for holding a great variety of accessories within the vehicle interior in easy reach of the driver and other occupants. The system is inexpensive to produce and is flexible such that it may be adapted for a number of accessories beyond those considered and disclosed herein.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a perspective view of the connector of the system for attaching an accessory to a vehicle interior of the disclosed invention;

FIG. 2 is a side view of the connector shown in FIG. 1;

FIG. 3 is a top plan view of the connector shown in FIGS. 1 and 2;

FIG. 4 is a side view of the receptacle for the system for attaching an accessory to a vehicle interior of the disclosed invention;

FIG. 5 is a top plan view of the receptacle shown in FIG. 4;

FIG. 6 is an underside view of a vehicle surface, herein a windshield visor, being fitted with the receptacle of FIGS. 4 and 5;

FIG. 7 is a front view of an accessory tissue holder for use with the system of the disclosed invention;

FIG. 8 is a back view of the accessory of FIG. 7;

FIG. 9 is a side view of the accessory of FIGS. 7 and 8;

FIG. 10 is a perspective view showing the upper side of a coin holder for use with the system of the disclosed invention;

FIG. 11 is a perspective view showing the lower side of the coin holder of FIG. 10;

FIG. 12 is a front view of a compact disk holder for use with the system of the disclosed invention;

FIG. 13 is a front view of a pen and card holder for use with the system of the disclosed invention;

FIG. 14 is a side view of a note pad holder for use with the system of the disclosed invention;

FIG. 15 is a side view of a sunglasses holder for use with the system of the disclosed invention;

FIG. 16 is a front view of a cellular telephone holder for use with the system of the disclosed invention;

FIG. 17 is the same view as FIG. 16 but illustrating a cellular telephone being fitted to the holder;

FIG. 18 is a back view of the cellular telephone holder of FIGS. 16 and 17;

FIG. 19 is a side view of a global positioning device holder for use with the system of the disclosed invention;

FIG. 20 is a bottom view of the global positioning device holder shown in FIG. 19;

FIG. 21 is a perspective view of the global positioning device holder shown in FIGS. 19 and 20 and further illustrating a global positioning device in position on the global positioning device holder; and

FIG. 22 is a perspective view of a pen holder for use with the system of the disclosed invention.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

The attachment portion of the disclosed invention includes a connector and a receptacle. The selected accessory is attached to the connector.

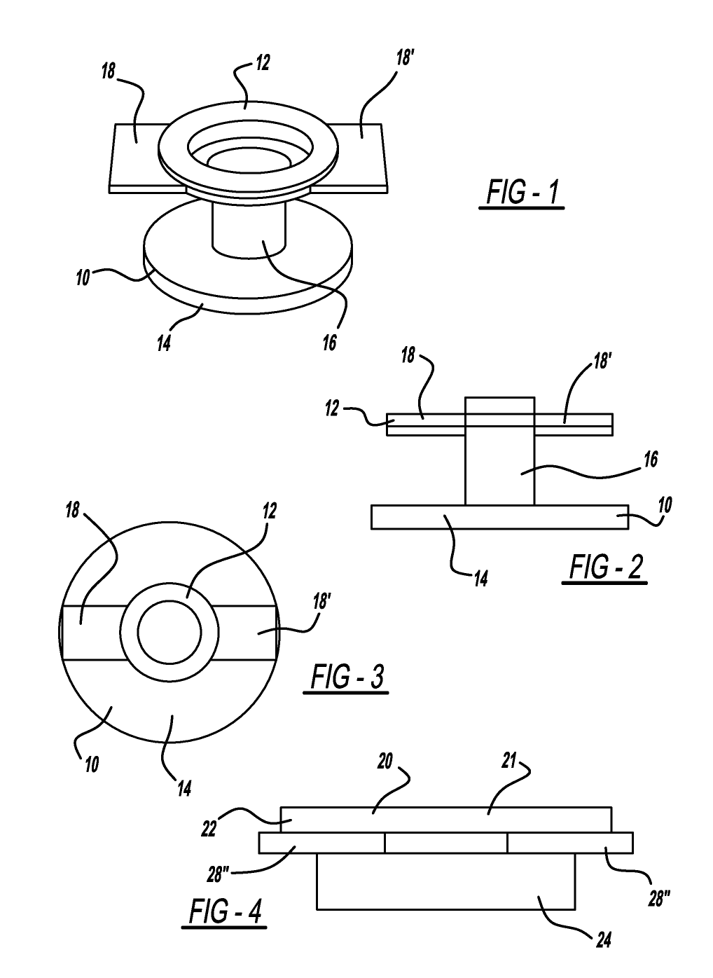

Referring to FIGS. 1 through 3, various views of a connector according to the disclosed invention, generally illustrated as 10, are shown. The connector 10 includes an upper connecting portion 12, a lower accessory attachment portion 14, and an intermediate portion 16. The upper connecting portion 12 includes arms for attaching the connector 10 to a receptacle. As shown, upper connecting portion 12 includes a pair of outwardly extending connecting arms 18 and 18′ for releasable attachment to the receptacle. It is to be understood that a greater or lesser number of connecting arms may be used. In addition, the arms may be of different shapes than those illustrated in FIGS. 1 through 3, although the illustrated arms reflect the preferred configuration.

The accessory attachment portion 14 may be of any configuration and may in fact be a part of the accessory holder itself as is shown and discussed below.

The intermediate portion 16 is illustrated as being cylindrical but may be of any of a variety of geometries.

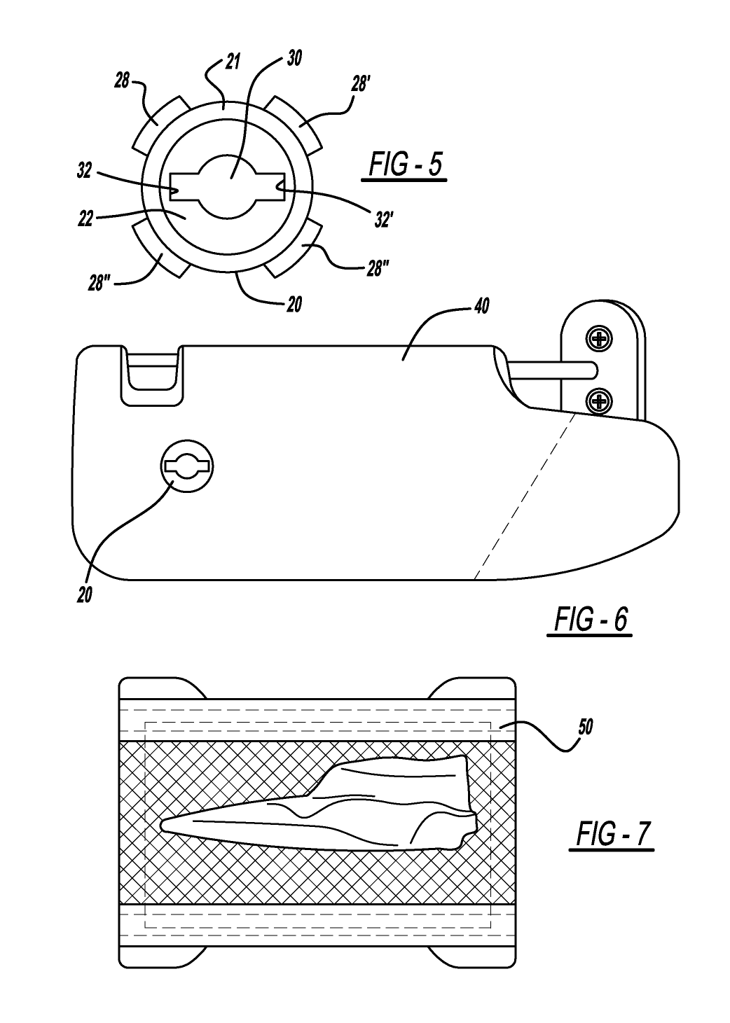

FIGS. 4 and 5 disclose views of the connector receptacle of the disclosed invention, generally illustrated as 20. The connector receptacle 20 includes a body 21 having an upper surface 22, a lower portion 24, and a plurality of vehicle interior surface attachment extensions 28, 28′, 28″ and 28′″. A greater or lesser number of attachment extensions may be used as is required for a particular application. While the preferred shapes of the attachment extensions 28, 28′, 28″, and 28′″ are illustrated, the shapes may themselves be altered as preferred.

The upper surface 22 of the receptacle has a connector-receiving keyway 30 formed therein. As is understood by those skilled in the art, the connector-receiving keyway 30 is shaped so as to snugly and securely receive and hold the connector 10. The keyway 30 includes a pair of opposed slots 32 and 32′ which are configured to releasably receive the outwardly extending connecting arms 18 and 18′ of the connector 10. The body 21 is essentially hollow so as to fully accommodate the outwardly extending connecting arms 18 and 18′ of the connector 10 after the connector 10 has been attached to the receptacle 20.

The connector 10 and the receptacle 20 may be made from a variety of materials including, for example, any of a broad variety of polymerized materials.

The accessory system of the disclosed invention may be used in conjunction with any one of a variety of surfaces of the motor vehicle interior. By way of example, FIG. 6 discloses the use of the receptacle 20 on the inner side of a sun visor 40. This arrangement allows for easy availability of any accessory attached thereto. However, it is to be understood that any vehicle interior surface may be used, including the instrument panel, armrests, door inner panel, and the like.

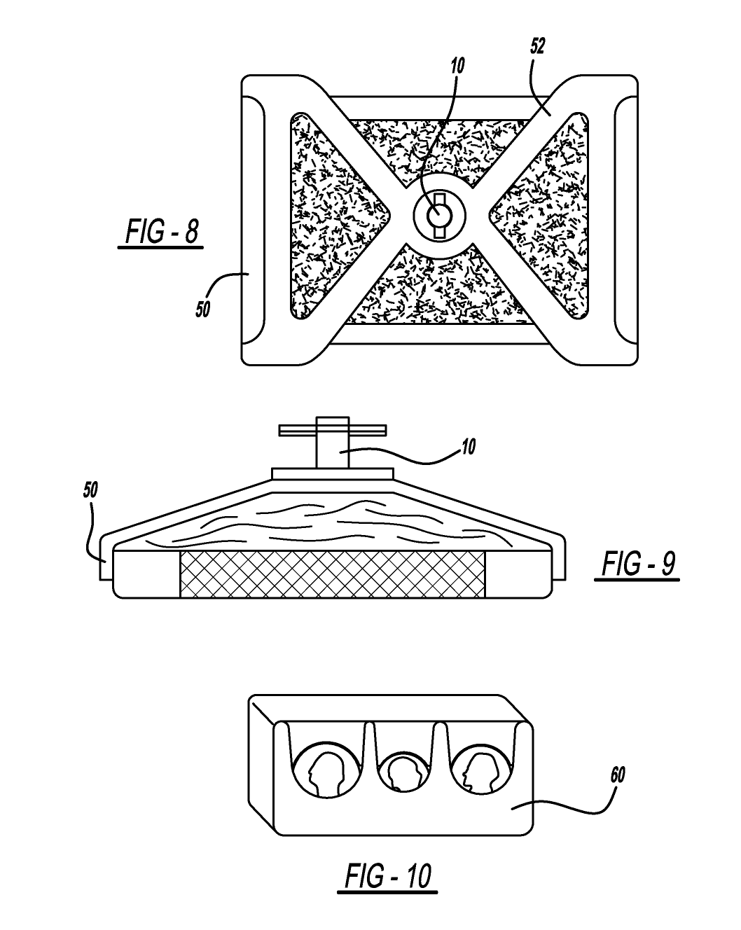

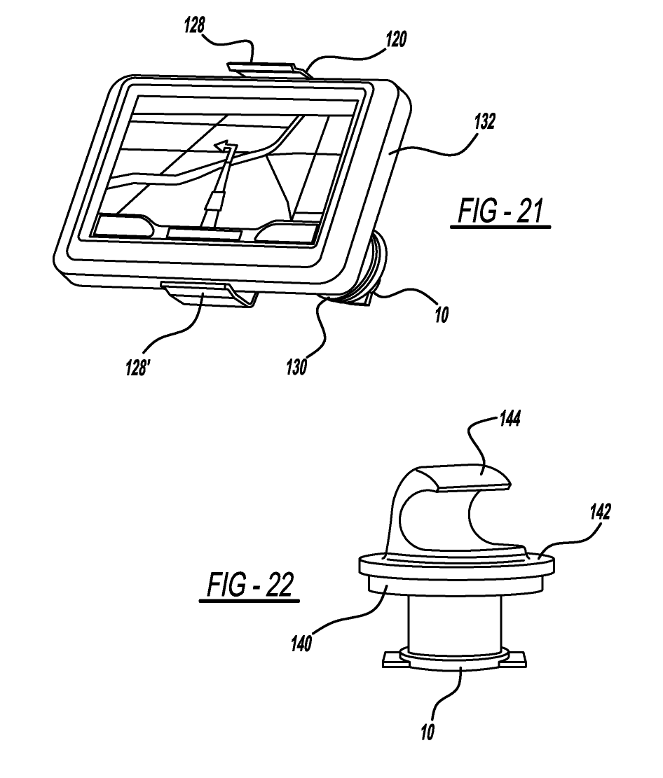

A great number of accessories may be attached using the system of the disclosed invention. Such accessories are shown in FIGS. 7 through 22.

With reference to FIGS. 7 through 9, an accessory tissue holder 50 is shown. The tissue holder 50 includes a body 52 to which the connector 10 is attached for attachment to the receptacle 20.

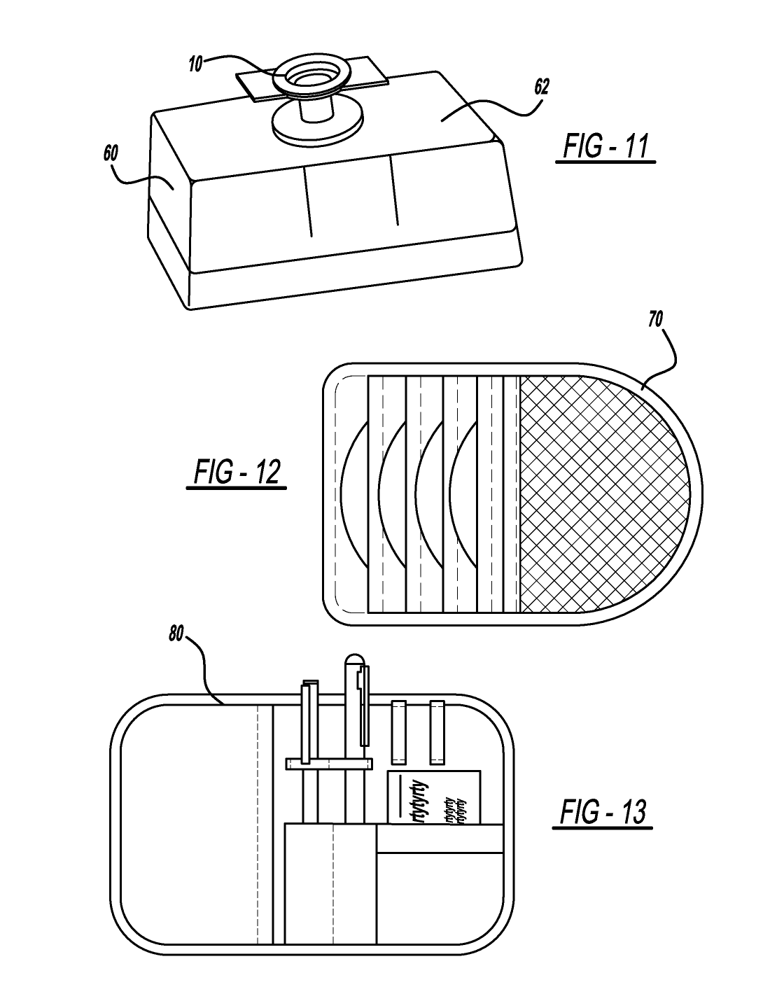

With reference to FIGS. 10 and 11, an accessory coin holder 60 is shown. The coin holder 60 includes a body 62 to which the connector 10 is attached for attachment to the receptacle 20.

With reference to FIG. 12 an accessory compact disk holder 70 is shown. This view illustrates the front side of the accessory compact disk holder 70. Fitted to the back side of the accessory compact disk holder 70 is a connector 10 (not shown) for attachment to the receptacle 20.

With reference to FIG. 13 a pen and credit card holder 80 is shown. This view illustrates the front side of the pen and credit card holder 80. Fitted to the back side of the accessory pen and credit card holder 80 is a connector 10 (not shown) for attachment to the receptacle 20.

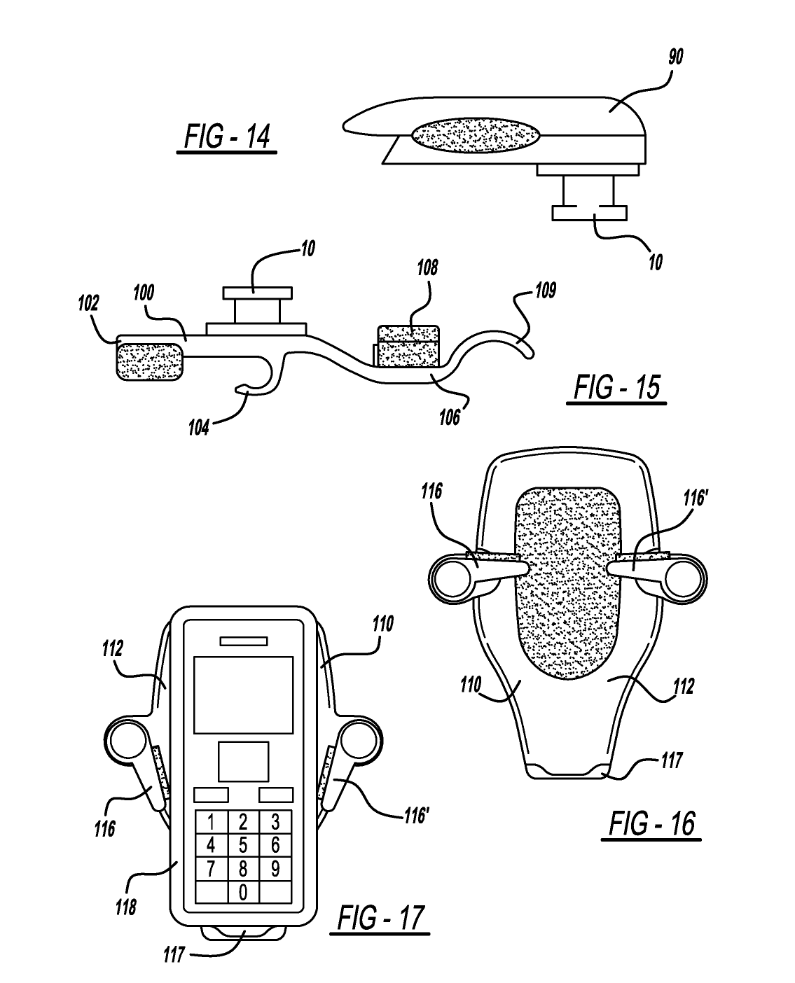

With reference to FIG. 14 an accessory note pad or card holder 90 is shown. The note pad or card holder 90 is spring loaded as is known in the art. The connector 10 is attached to the underside of the note pad or card holder 90 for attachment to the receptacle 20.

With reference to FIG. 15 an accessory sunglasses holder 100 is shown. The sunglasses holder 100 includes a first end 102 having a sunglasses bridge attachment arm 104 and a second end 106 having a holding pad 108 and a tab 109. The connector 10 is attached to the underside of the sunglasses holder 100.

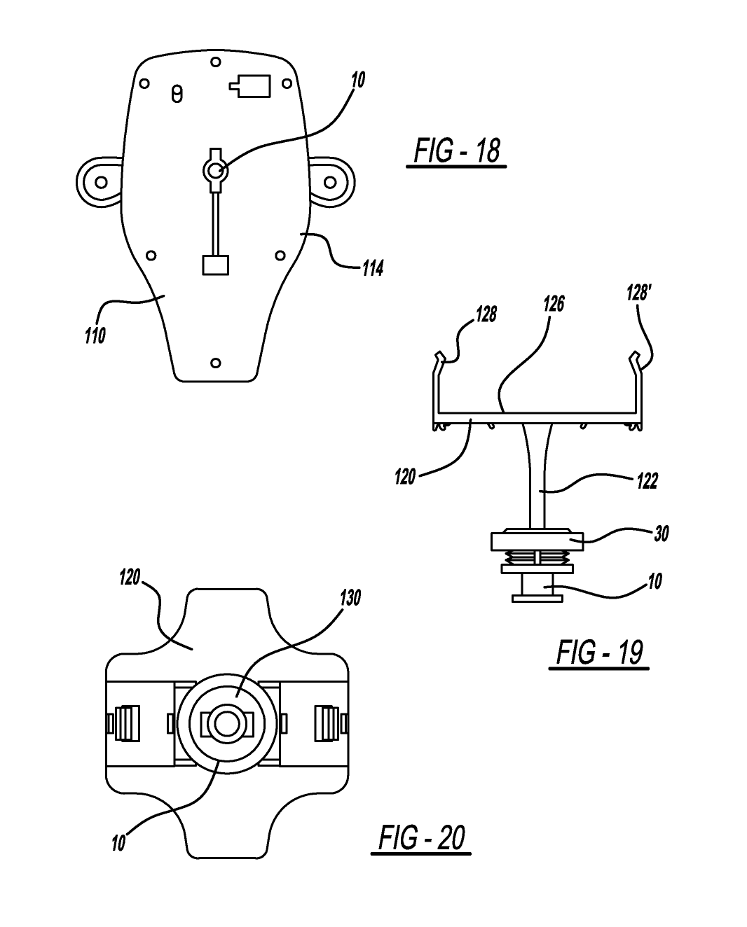

With reference to FIGS. 16 through 18 an accessory cellular telephone holder 110 is shown. The accessory cellular telephone holder 110 includes a telephone holding front side 112 shown in FIGS. 16 and 17 and a back side 114 shown in FIG. 18. On the front side 112 are provided a pair of spring loaded movable arms 116 and 116′. Also provided on the front side 112 is an outwardly-extending telephone supporting shelf 117. A cellular telephone 118 (shown in FIG. 17) rests between and is held by the spring loaded movable arms 116 and 116′ and upon the outwardly-extending telephone supporting shelf 117. The connector 10 is attached to the back side 114 and is provided for attachment to the receptacle 20.

With reference to FIGS. 19 through 21 an accessory global positioning system device holder 120 is shown. The accessory global positioning system device holder 120 includes an arm 122 and a body 124. The body 124 includes an upper surface 126. A pair of inwardly-bent device gripping arms 128 and 128′ extend outwardly from the body 124. The arm 122 is pivotably attached to a connector assembly 130 to which the connector 10 is attached for attachment to the receptacle 20. A global positioning device 132 is shown fitted to the global positioning system device holder 120. The global positioning device 132 is held in place against the upper surface 126 of the body 124 by tension.

With reference to FIG. 22 an accessory pen holder 140 is shown. The accessory pen holder 140 includes a body 142 and a pen clip 144 extending from the body 142. The connector 10 is attached to the body 142 for attachment to the receptacle 20.

In use, to attach the connector 10 and its fitted accessory to the vehicle surface, the operator grasps the assembly and positions the outwardly extending arms 18 and 18′ of the upper connecting portion 12 such that they are in line with the keyway 30 of the connector receptacle 20. The operator then inserts the upper connecting portion 12 into the keyway 30 and rotates the upper connecting portion 12 within the keyway 30 so as to lock the upper connecting portion 12 within the keyway 30. Ordinarily this locking maneuver may be accomplished by a ¼ turn. Removal of the connector 10 and its accompanying accessory is achieved in reverse order of the steps needed for attachment. Each accessory is fitted with its own connector 10 and, accordingly, interchanging one accessory for another is a simple task.

It is to be understood that the accessories illustrated and discussed herein are exemplary only and that a great many other accessories may be attached by the disclosed system, including, for example, cup and map holders.

The foregoing discussion discloses and describes exemplary embodiments of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A system for holding an accessory to a surface of a vehicle, the system comprising:
a connector having a cylindrical body, said body having a long axis and an upper portion and a lower portion, said upper portion having at least two arms extending generally perpendicularly therefrom, said lower portion having an accessory holder attachment surface; and
a receptacle having a body, said body having an upper surface with an aperture formed therein, said aperture having a circular central portion and at least two slots extending from said circular central portion, said body including at least two extensions for attaching said receptacle to the surface of the vehicle.

2. The system for holding an accessory to a surface of a vehicle of claim 1 wherein said connector is composed of a polymerized material;

3. The system for holding an accessory to a surface of a vehicle of claim 1 wherein said receptacle is composed of a polymerized material.

4. The system for holding an accessory to a surface of a vehicle of claim 1 wherein said at least two extensions comprise a pair of spaced apart elongated arms.

5. An accessory holding system for use with a vehicle surface, the system comprising:
a receptacle having an opening therein, said opening defining an elongated slot;
a connector having a cylindrical body and a pair of arms extending therefrom for twisting connection with said opening of said receptacle; and
an accessory attached to said connector.

6. The accessory holding system of claim 5 wherein said slot has a round central portion.

7. The accessory holding system of claim 6 wherein said slot has two openings extending radially from said central portion.

8. The accessory holding system of claim 7 wherein said receptacle has a body and fasteners for attaching said body to said vehicle.

9. The accessory holding system of claim 8 wherein said fasteners define a plurality of extension members extending from said body.

10. The accessory holding system of claim 5 further including an accessory taken from the group consisting of a tissue holder, a coin holder, a compact disk holder, a pen holder, a note pad holder, a sunglasses holder, a cellular telephone holder, and a global positioning holder.

11. The accessory holding system of claim 5 wherein said connector is composed of a polymerized material;

12. The accessory holding system of claim 5 wherein said receptacle is composed of a polymerized material.

13. A system for holding an accessory to a surface of the interior of a vehicle, the system comprising:
a connector having a body, said body having an upper portion and a lower portion, said upper portion having at least two arms extending generally perpendicularly therefrom, said lower portion having an accessory holder attachment surface; and
a receptacle having a body, said body having an upper surface with an aperture formed therein, said aperture having a central portion and at least two slots extending from said circular central portion, said body of said connector being shaped to substantially fit within said central portion of said receptacle; and
an accessory attached to said accessory holder attachment surface of said lower portion of said connector.

14. The system for holding an accessory to a surface of the interior of a vehicle of claim 13 wherein said body has a long axis and wherein said arms are generally perpendicular to said long axis.

15. The system for holding an accessory to a surface of the interior of a vehicle of claim 14 wherein said connector is composed of a polymerized material;

16. The system for holding an accessory to a surface of the interior of a vehicle of claim 13 wherein said receptacle is composed of a polymerized material.

17. The system for holding an accessory to a surface of the interior of a vehicle of claim 13 wherein said fasteners comprise a plurality of extension members extending from said body of said receptacle.

18. The system for holding an accessory to a surface of the interior of a vehicle of claim 13 wherein said body includes fasteners for attaching said receptacle to the surface of the vehicle.

19. The system for holding an accessory to a surface of the interior of a vehicle of claim 13 wherein said body of said connector is cylindrical.

20. The system for holding an accessory to a surface of the interior of a vehicle of claim 13 wherein said accessory is selected from the group consisting of a tissue holder, a coin holder, a compact disk holder, a pen holder, a note pad holder, a sunglasses holder, a cellular telephone holder, and a global positioning holder
